(19) United States
(12) Patent Application Publication
(10) Pub. No.: US 2016/0259237 A1
(43) Pub. Date: Sep. 8, 2016

(54) SIDE VIEW DOWNHOLE CAMERA AND LIGHTING APPARATUS AND METHOD

(71) Applicant: ABRADO, INC., Houston, TX (US)

(72) Inventors: Marshal Harris, Houston, TX (US); Philip Schultz, Houston, TX (US); Christopher Meyers, Houston, TX (US); Bruce Beacom, Houston, TX (US)

(73) Assignee: ABRADO, INC., Houston, TX (US)

(21) Appl. No.: 15/035,790

(22) PCT Filed: Nov. 19, 2014
(86) PCT No.: PCT/US14/66411

§ 371 Date: May 11, 2016

Related U.S. Application Data
(60) Provisional application No. 61/906,457, filed on Nov. 20, 2013.

(51) Int. Cl. G03B 37/00; H04N 7/18; E21B 47/00

(52) U.S. Cl. CPC G03B 37/005; E21B 47/0002; H04N 7/185

(57) ABSTRACT

A downhole camera assembly (100) comprises a camera having a side-view viewport (82) that can be conveyed and manipulated within a wellbore on flexible cable. Light emitted from a light source is diffused and directed by a transparent or translucent material (61) in a substantially 360-degree pattern within a wellbore, thereby illuminating portion(s) of the wellbore positioned laterally to the camera assembly in a field of view of the viewport. The viewport may be selectively rotated 360 degrees by a motor assembly (40) positioned within the camera assembly which can be controlled from the earth's surface.

### TECHNICAL FIELD

The present invention pertains to a camera and associated lighting system for use in unlighted and/or harsh environments. More particularly, the present invention pertains to a downhole illuminated camera systems for use in wells penetrating subterranean formations including, without limitation, oil and/or gas wells.

### BACKGROUND ART

Downhole camera systems exist for obtaining video and/or still visual images in wellbores. However, most wellbores contain little or no existing source of ambient or available light. Accordingly, a light source must typically be provided in order to illuminate downhole portions of a wellbore when use of a camera or other visual image sensor in such areas is desired.

Certain conventional downhole camera systems utilize lamp(s) or other light sources to illuminate downhole portions of a wellbore for viewing. In one example, an incandescent light bulb is placed behind a camera body having a reflector. In another example, a low voltage and/or low power incandescent lamp is used for this purpose. Other conventional downhole camera systems utilize an array of light-emitting diodes (LEDs) placed around a lens of a camera.

However, all conventional means for downhole illumination suffer from a number of significant limitations. For example, placement of a light source behind a camera with a reflector typically leaves a large dark section in a camera's field of view; such dark section is caused by a camera body being positioned in front of the light source. In particular, as the size of a surrounding wellbore diameter is decreased, problems with existing light source systems typically increase. In smaller pipe, a camera acts as a light choke preventing light from entering into said camera's field of view.

Further, conventional downhole camera systems are generally designed for viewing in a direction that is oriented in alignment with and/or parallel to the longitudinal axis of a wellbore. Such an orientation is typically in a downward or “downhole” direction in a wellbore. Although some conventional downhole camera systems do permit lateral viewing—that is, viewing in a direction that is substantially perpendicular to the longitudinal axis of a wellbore—lighting/illumination of such lateral areas can be particularly challenging. Width restrictions within a wellbore (i.e., the available “side-to-side” space within the internal diameter of a wellbore) are significantly limited, particularly when such available space must be shared with camera components and/or other equipment.

Because it is difficult to illuminate a relatively narrow wellbore having limited space with a narrow tool, conventional downhole camera systems typically utilize direct lighting techniques, such as placing LEDs close or next to a side-viewing camera lens. However, such direct lighting typically results in problems such as an increase in shadows and dark spots in video captured. Thus, there is a need for a relatively thin camera and lighting assembly that can provide illumination within a wellbore for acquisition of video or other visual images including, without limitation, of subject matter that is positioned substantially perpendicular to the longitudinal axis of said wellbore. Such camera and lighting assembly should be capable of performing visual inspection and recording of wellbore environments including views that are substantially perpendicular to a deployed camera assembly and associated equipment, such as the internal wall of a wellbore. Further, such camera and lighting assembly should allow a real-time video feed to be acquired downhole and transmitted to the earth's surface from a downhole camera positioned within a wellbore.

### DISCLOSURE OF INVENTION

The present invention comprises a method and apparatus for beneficially illuminating a portion of a wellbore environment. Live video data or other visual images can be acquired within said wellbore, and recorded in onboard storage and/or transmitted to the earth's surface for viewing and/or other purposes. In addition to downward views (that is, views that are substantially aligned with the longitudinal axis of a wellbore), the present invention allows viewing of subject matter that is positioned substantially perpendicular to the longitudinal axis of said wellbore.

In a preferred embodiment, the present invention comprises a camera assembly that can be suspended and manipulated within a wellbore via an electric line cable. Said cable also provides a transmission medium for providing power to said camera assembly, as well as a conduit for transmission of data (such as, for example, video or other visual images) from said camera assembly to the earth's surface. The camera assembly of the present invention further comprises at least one transmitter and receiver allowing for live video and/or other visual images to be viewed at the earth's surface, while permitting operational commands to be sent to and received by said camera assembly.

A significant advantage of the present invention includes the ability to significantly illuminate a portion of a wellbore environment within a field of view of a camera having a side viewport. Illumination of acquired data (such as, for example, video or other visual images) is achieved through use of a light tube positioned near a viewport, thereby permitting transmission of light from a light source through a translucent or transparent material, which, in turn, emits light into a surrounding wellbore. It is to be observed that said light transmitting and/or diffusing material is described herein primarily as being translucent; however, depending on anticipated wellbore fluids and/or other conditions, in certain applications said material may be transparent rather than translucent.

A light source, such as a light emitting diode (“LED”), is positioned near (embedded, abutted, or positioned within close proximity to) a substantially cylindrical and substantially translucent material. Light generated by said source is diffused and emitted by said translucent material in a substantially 360 degree pattern within a wellbore, thereby illuminating a portion of said wellbore. Such translucent material may be positioned above or below a camera having a side-view viewport, while said viewport may be selectively rotated 360 degrees by a rotating motor positioned within said camera assembly.

In a preferred embodiment, translucent material is housed within a “cage” to provide protection from scarring and to reinforce the overall stability of the camera assembly. “Cutouts” or gaps are beneficially provided in the cage design to allow for the emission of light into the surrounding wellbore.

The camera assembly of the present invention can be lowered within a wellbore, deployed to a desired location within said wellbore, and thereafter retrieved from said wellbore. Although jointed or continuous pipe or other tubular goods can be used to convey such camera assembly in and out of wellbores, it is typically more operationally efficient and cost-effective to utilize flexible wireline or cable to convey such camera systems in such wellbores.

In such cases, a sufficient length of wireline or cable is maintained on a spool or drum at the earth's surface near the upper opening of a wellbore. The distal or leading end of said wireline is connected to the camera assembly of the present invention. Said leading end (and any attached tools) are vertically aligned over the upper opening of a wellbore and suspended in place using an arrangement of beneficially positioned sheaves or pulleys. Said wireline and any attached tools can then be conveyed into a wellbore by unspooling said wireline from said spool, manipulated within said wellbore, and then retrieved from said well by re-winding said wireline on said spool.

Generally, such wireline can comprise conductive electric line or “E-line” that permits the transmission of electrical charges and/or data through said wireline, or non-conductive “slickline” that does not permit such transmission of data or electrical charges. Either type of wireline can be used to convey the camera assembly of the present invention in and out of wellbores, and to obtain visual images of wellbore environments. However, only electric line can be used to convey electrical charges and data to and from a downhole camera assembly to the earth's surface; slick line does not have this capability.

Thus, in a preferred embodiment, the camera assembly of the present invention is conveyed in and out of a wellbore via electric line which permits the transmission of live images or video from a downhole wellbore environment to the earth's surface, where such data can be viewed and stored for subsequent transmission, review, and/or evaluation. Moreover, the camera assembly of the present invention is sufficiently narrow to fit through the smallest reasonably-expected clearance size in typical wellbores (1-11/16″ OD), which allows for passage of the camera assembly through a wellbore without getting stuck.

### BRIEF DESCRIPTION OF DRAWINGS

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side perspective view of a downhole side view camera assembly of the present invention.

FIGS. 2A and 2B depict exploded views of a downhole side view camera assembly of the present invention.

FIG. 3 depicts a sectional view of a downhole side view camera assembly of the present invention.

### BEST MODE FOR CARRYING OUT THE INVENTION

The application on which this application claims priority under 35 USC 119(e), U.S. Provisional Patent Application No. 61/906,457, filed Nov. 20, 2013, is hereby incorporated herein by reference. The present invention comprises a method and apparatus for beneficially illuminating a portion of a downhole wellbore environment. Live video data or other visual images can be acquired within said wellbore, and recorded to onboard data storage and/or transmitted to the earth's surface for viewing, evaluation and/or other purposes. In addition to downward views (that is, views that are substantially aligned with the longitudinal axis of a wellbore and oriented generally toward the distal end of said wellbore), the present invention permits viewing of subject matter that is positioned laterally to said apparatus—that is, subject matter that is positioned substantially perpendicular to the longitudinal axis of said wellbore.

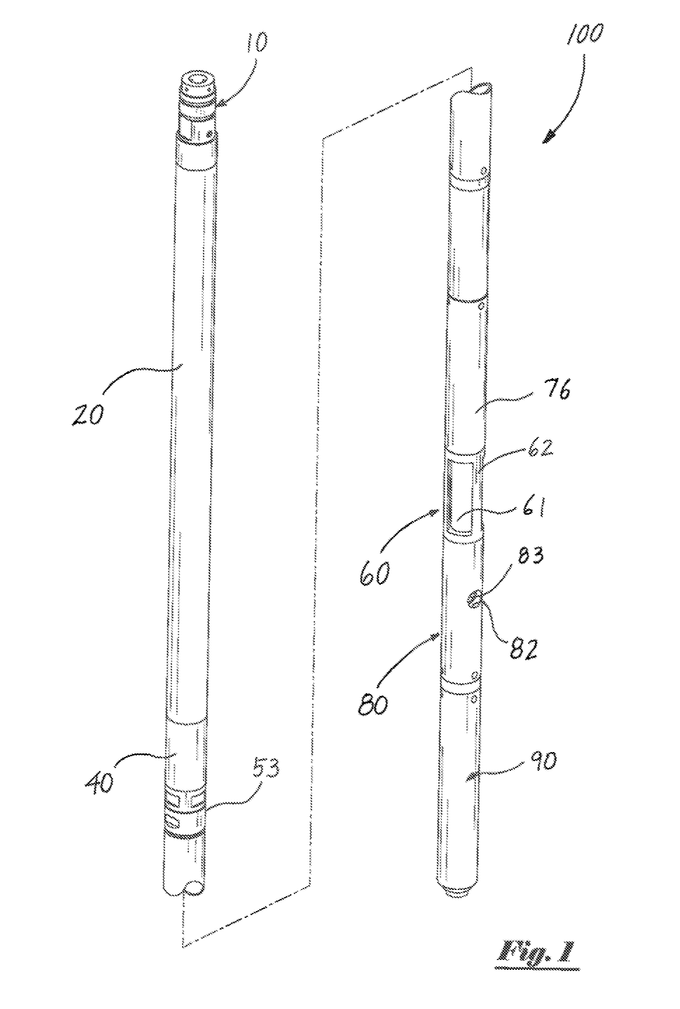

FIG. 1 depicts a side perspective view of a downhole side view camera assembly 100 of the present invention. Camera assembly 100 that can be lowered within a wellbore, deployed to a desired location within said wellbore and thereafter retrieved from said wellbore. As discussed above, jointed or continuous pipe or other tubular goods can be used to convey such camera assembly in and out of wellbores. However, it is typically more operationally efficient and cost-effective to utilize flexible wireline or cable to convey such camera systems in such wellbores.

In a preferred embodiment, camera assembly 100 of the present invention is conveyed in and out of a wellbore typically via an electric line cable (not depicted in FIG. 1, but well known to those having skill in the art). Said electric line cable also provides a transmission medium for providing power to said camera assembly, as well as a conduit for transmission of operational commands from the earth's surface downhole to said camera assembly 100, and data (such as, for example, video or other visual images acquired downhole) from said camera assembly 100 to the earth's surface.

Still referring to FIG. 1, camera assembly 100 generally comprises at least one substantially cylindrical outer pressure housing 20 for containing certain components of camera assembly 100, such as electronics and communications assembly. A connector head assembly 10 is positioned at or near the upper or proximate end of said camera assembly 100, to permit desired connection of said camera assembly 100 to a length of electric line or other conveying means. Although other means of connection can be utilized without departing from the scope of the present invention, it is to be observed that connector head assembly 10 can comprise a “go pin” type wireline connection assembly well know to those having skill in the art of wellbore wireline operations.

Camera assembly 100 further comprises motor assembly 40. Said motor assembly 40 can comprise various components well known to those having skill in the art of wireline operations such as, for example, a slip ring connector and a motor shaft coupling. A motor shaft is connected to a rotating joint assembly 53 that provides a dynamic fluid pressure seal during rotation of said rotating joint assembly 53.

A light source is positioned within a light source housing 76 near side lighting assembly 60. In a preferred embodiment, said side lighting assembly 60 comprises a substantially cylindrical lighting member 61 constructed of substantially translucent material, contained within a cage member 62; said cage member 62 provides a protective container or housing for lighting member 61, but includes cut-outs, openings or gaps to permit light passing through said lighting member 61 to be directed through said cage member 62 into a surrounding wellbore. As noted above, the light transmitting and/or diffusing material of cylindrical lighting member 61 is described herein primarily as being translucent; however, depending on anticipated wellbore fluids and/or other conditions, in certain applications said material may be transparent rather than translucent. Further, it is to be observed that in certain applications a transparent material may be preferred over a translucent material.

A side view camera assembly 80 is mounted, typically in a mounting chassis 84, in proximity relative to side lighting assembly 60. Side view camera assembly 80 can comprise a camera (or other optical sensor) having a lens 83 directed out of side view port 82; said lens 83 has a view field oriented substantially parallel to the longitudinal axis of camera assembly 100 and a surrounding wellbore section. An additional camera assembly 90 having a second camera or other optical sensor having a generally downwardly facing lens can be included as part of camera assembly 100. In addition to data acquired using side view camera assembly 80, camera assembly 90 allows for acquisition of visual images or other data generally oriented in a direction toward the proximate (typically lower) end of a wellbore.

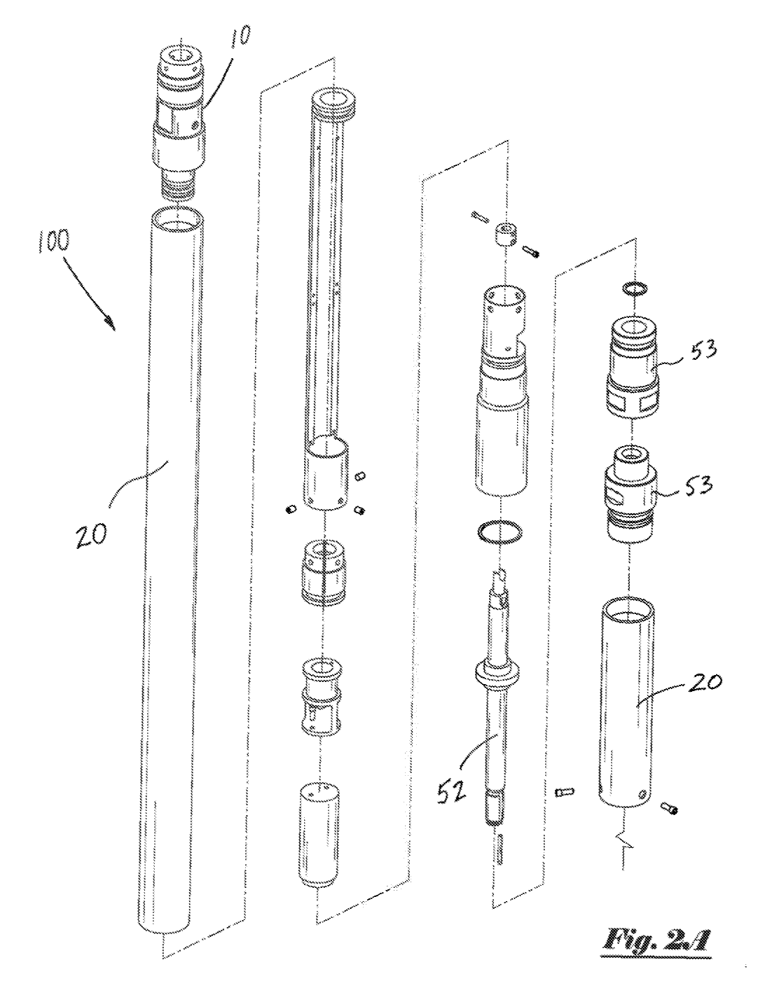

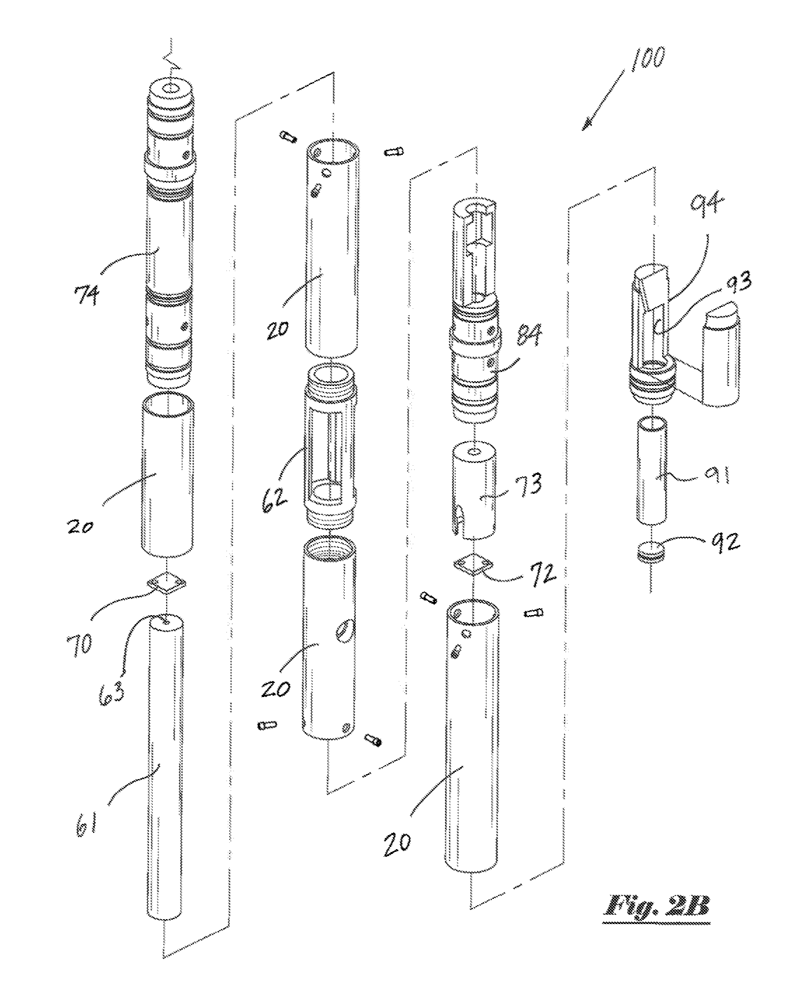

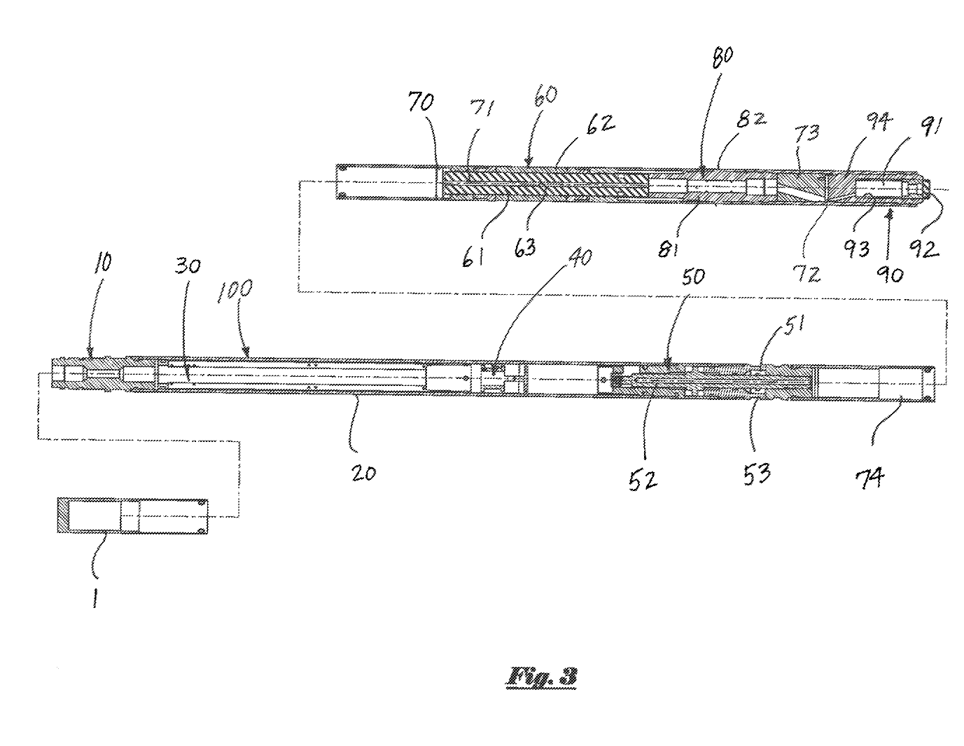

FIGS. 2A and 2B depict exploded views of a downhole side view camera assembly 100 of the present invention, while FIG. 3 depicts a sectional view of downhole side view camera assembly 100 of the present invention. Referring to said figures, camera assembly 100 generally comprises a substantially cylindrical outer housing 20 for containing certain components of camera assembly 100. A connector head assembly 10 is positioned at or near the upper or proximate end of said camera assembly 100, to permit desired connection of said camera assembly 100 to a length of electric line or other conveying means. Although other means of connection can be utilized without departing from the scope of the present invention, it is to be observed that connector head assembly 10 can comprise a “go pin” type wireline connection assembly well know to those having skill in the art of wellbore wireline operations. An optional end cap 1 can be provided to cover connector head assembly 10 when camera assembly 100 is not attached to wireline.

In a preferred embodiment, an electronics and communication assembly 30 can be connected to said connector head assembly 10. Said electronics and communication assembly 30 can comprise electronic components (including, without limitation, at least one computer processor) to operate and control certain functions of camera assembly 100. Said electronics and communication assembly 30 can further comprise at least one transmitter for transmitting data (such as live video and/or other visual images acquired by camera assembly 100) via electric line to a receiver positioned at the earth's surface, as well as at least one receiver for receiving data (such as operations commands for camera assembly 100 sent from the earth's surface) via electric line to said camera assembly 100.

Camera assembly 100 can further comprise motor assembly 40. Said motor assembly can comprise various components well known to those having skill in the art of wireline operations such as, for example, a slip ring connector and a motor shaft coupling. Motor assembly 40 connects to motor shaft assembly 50 and drives a rotatable motor shaft 52. In a preferred embodiment, said motor shaft 52 rotates about an axis that is generally parallel to the longitudinal axis of camera assembly 100.

Said motor shaft 52 can connect to a rotating joint assembly 53 that permits rotation of components connected to said motor shaft 52; as a result, rotation of said motor shaft 52, can result in rotation of rotating joint assembly 53 and, thus, any components of camera assembly 100 positioned below said rotating joint assembly 53. Rotating joint assembly 53 can include a dynamic fluid pressure seal assembly 51 which provides for a fluid pressure seal even during rotation of said rotating joint assembly 53. In a preferred embodiment, said dynamic fluid pressure seal assembly 51 is the only dynamic fluid pressure seal in camera assembly 100, thereby reducing the likelihood of failure from multiple such fluid pressure seal assemblies.

A light source, such as a light emitting diode (“LED”) 70, is positioned near (embedded, abutted, or positioned within close proximity to) side lighting assembly 60. A heat sink assembly 74 can be provided. In a preferred embodiment, said side lighting assembly 60 comprises a substantially cylindrical lighting member 61 constructed of substantially translucent material. Said lighting member 61 can be contained within a cage member 62; said cage member 62 provides a protective container or housing for lighting member 61, but includes cut-outs, openings or gaps to permit light passing through said lighting member 61 to be directed through said cage member 62 into a surrounding wellbore. Cage member 62 provides protection to lighting member 61 from scarring and to reinforce the overall stability of camera assembly 100.

Light generated by light source 70 is diffused and emitted by translucent lighting member 61 in a substantially 360 degree pattern around the inner diameter (inner surface) of a wellbore, thereby illuminating a portion of said wellbore in the vicinity of said lighting member 61. In a preferred embodiment, translucent lighting member 61 can also comprise a central bore 63.

An optional light source 71, which can be an elongate LED strip or other beneficially configured light source, can be disposed within said central bore 63. Said optional light source 71 can provide additional illumination in addition to, or in place of, light source 70. In certain applications, use of an optional light source 71 within said central bore 63 results in more dispersed light along the length of lighting member 61. In such case, light can be more effectively diffused by reflecting off of more surface area instead of along the length of tubular lighting member 61.

A side view camera assembly 80 is mounted in proximity relative to side lighting assembly 60. Although said side view camera assembly is depicted in FIG. 1 as being mounted generally below said side lighting assembly 60, it is to be observed that said cameral assembly 80 and side lighting assembly 60 can have different relative positioning within camera assembly 100 without departing from the scope of the present invention. Side view camera assembly 80 can comprise camera 81 (or other optical sensor) having a side view port 82 and side view lens 83 which has a view field oriented substantially perpendicular to the longitudinal axis of camera assembly 100 and a surrounding wellbore section.

Camera assembly 100 can further include a heat sink assembly 73 and optional additional light source (such as, for example, an LED) 72. A substantially cylindrical and tubular light pipe 94 having a central bore 93 can be disposed below said light source 72, while an additional camera 91 having downwardly facing lens 92 can be disposed within said bore 93. Tubular light pipe 94 can be constructed of a translucent or transparent material that permits the transmission and distribution of light from additional light source 72. In addition to data acquired using side view camera assembly 80, additional camera 91 allows for acquisition of visual images or other data generally oriented in a direction toward the proximate (typically lower) end of a wellbore.

A significant advantage of the present invention includes the ability to significantly illuminate a portion of a wellbore environment within a field of view of a camera 81 having a side viewport 82. Illumination of acquired data (such as, for example, video or other visual images) is achieved through use of lighting member 61 positioned in general proximity to said viewport 82, thereby permitting transmission of light from light source 70, through translucent lighting member 61, which, in turn, diffuses and emits light into a surrounding wellbore for illumination of said wellbore. Viewport 82 may be selectively rotated 360 degrees by rotating motor shaft 52 using motor 40.

Deployment of camera assembly 100 via electric line also allows for real-time downhole control of said camera assembly 10. For example, lens 83, which is oriented generally perpendicular to the longitudinal axis of a wellbore, only points in one direction and typically has a limited field of view. Real-time control of the motor assembly of camera assembly 100 allows for a 360 degree rotation of said lens 83 to permit viewing of all areas along the inner circumferential surface of said wellbore. This ability is especially beneficial because the orientation of side view camera lens 83 cannot be controlled by rotating cable from the surface like with jointed pipe.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. An illumination and visual sensor assembly for use in a wellbore comprising:
a) a light source;
b) a visual sensor having a view field oriented substantially perpendicularly to the longitudinal axis of said wellbore; and
c) a translucent material disposed between said light source and said visual sensor, wherein light from said light source is conveyed via said translucent material to provide illumination within said view field.

2. The wellbore illumination and visual sensor assembly of claim 1, further comprising a motor for rotating said view field within said wellbore.

3. The wellbore illumination and visual sensor assembly of claim 2, wherein said view field is rotated about an axis that is oriented substantially parallel to the longitudinal axis of said wellbore.

4. The wellbore illumination and visual sensor assembly of claim 1, further comprising a cage assembly disposed around said translucent material.

5. The wellbore illumination and visual sensor assembly of claim 1, further comprising at least one thermal insulation barrier disposed between said light source and said visual sensor.

6. The wellbore illumination and visual sensor assembly of claim 1, further comprising:
a) a substantially tubular light pipe having first end, a second end and a central bore extending there through; and
b) a second visual sensor having a second view field, wherein said second visual sensor is at least partially disposed within said central bore, and light from said light source is conveyed via said light pipe past said second visual sensor to illuminate said second view field.

7. The wellbore illumination and visual sensor assembly of claim 1, wherein said light source comprises at least one light emitting diode.

8. A wellbore illumination and video camera assembly for use in a wellbore comprising:
a) a pressure sealed housing having a first end, a second end and a length;
b) a light source disposed within said housing;
c) a visual sensor disposed within said housing having a view field oriented substantially perpendicularly to the longitudinal axis of said wellbore; and
d) a translucent material disposed between said light source and said visual sensor, wherein light from said light source is conveyed via said translucent material to provide illumination within said view field.

9. The wellbore illumination and visual sensor assembly of claim 8, further comprising a motor for rotating said view field within said wellbore.

10. The wellbore illumination and visual sensor assembly of claim 9, wherein said view field is rotated about an axis that is oriented substantially parallel to the longitudinal axis of said wellbore.

11. The wellbore illumination and visual sensor assembly of claim 8, further comprising a cage assembly disposed around said translucent material.

12. The wellbore illumination and visual sensor assembly of claim 8, further comprising at least one thermal insulation barrier disposed between said light source and said visual sensor.

13. The wellbore illumination and visual sensor assembly of claim 8, further comprising:
a) a substantially tubular light pipe having first end, a second end and a central bore extending there through; and
b) a second visual sensor having a second view field, wherein said second visual sensor is at least partially disposed within said central bore, and light from said light source is conveyed via said light pipe past said second visual sensor to illuminate said second view field.

14. The wellbore illumination and visual sensor assembly of claim 13, wherein said second view field is oriented out of the second end of said housing.

15. The wellbore illumination and visual sensor assembly of claim 8, wherein said light source comprises at least one light emitting diode.
